(19) United States
(12) Patent Application Publication
(10) Pub. No.: US 2010/0270488 A1
(43) Pub. Date: Oct. 28, 2010

(54) Fuel Can Adapter

(76) Inventor: Arlo Lin, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/624,559

(22) Filed: Nov. 24, 2009

(30) Foreign Application Priority Data
Apr. 22, 2009 (TW) 98113370

(51) Int. Cl. F16L 29/00

(52) U.S. Cl. 251/148

(57) ABSTRACT

A fuel can adapter is adapted to connect a fuel can to a fuel device. Once the fuel can adapter is connected therebetween, the fuel can adapter is operable in one operation position to cause fuel in the fuel can to be discharged and flow through it to the fuel device, and another operation position that fuel in the fuel can would not flow thereout.

### BACKGROUND OF THE INVENTION

1. Field of the Invention

The present invention relates to a fuel can adapter and, in particular, to a fuel can adapter which is in fluidal connection between a fuel can and a fuel device and which can selectively allow or stop fuel in the fuel can to flow to the fuel device.

2. Description of the Related Art

FIG. 10 shows a conventional fuel can 3′ connected to a conventional fuel device 2. The fuel can 3′ includes a head which has a threaded section formed on its outer periphery, and a valve disposed in the head. The fuel device 2 includes a fuel can connecting section including a cavity which has an open end and a threaded section formed on its peripheral wall. The fuel can connecting section also includes a needle disposed in the cavity and extending outwards the open end. In use, the fuel can 3′ is connected to the fuel device 2 by inserting the head through the open end of the cavity and by threadly engaging the head in the cavity, and then the needle would urge the valve to open to allow fuel flow out from the fuel can 3′. Because when in process of threading the head into the cavity, the needle would gradually cause the valve to open and the fuel starts to flow out of the fuel can 3′, however, this is not safe and might suffer a risk of fuel leakage.

The present invention is, therefore, intended to obviate or at least alleviate the problems encountered in the prior art.

### SUMMARY OF THE INVENTION

According to the present invention, a fuel can adapter is adapted to connect a fuel can to a fuel device. Once the fuel can adapter is connected therebetween, the fuel can adapter is operable in one operation position to cause fuel in the fuel can to be discharged and flow through it to the fuel device, and another operation position that fuel in the fuel can would not flow thereout.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

FIG. 1 is a perspective view of a fuel can adapter in accordance with the present invention connecting a fuel can to a fuel device.

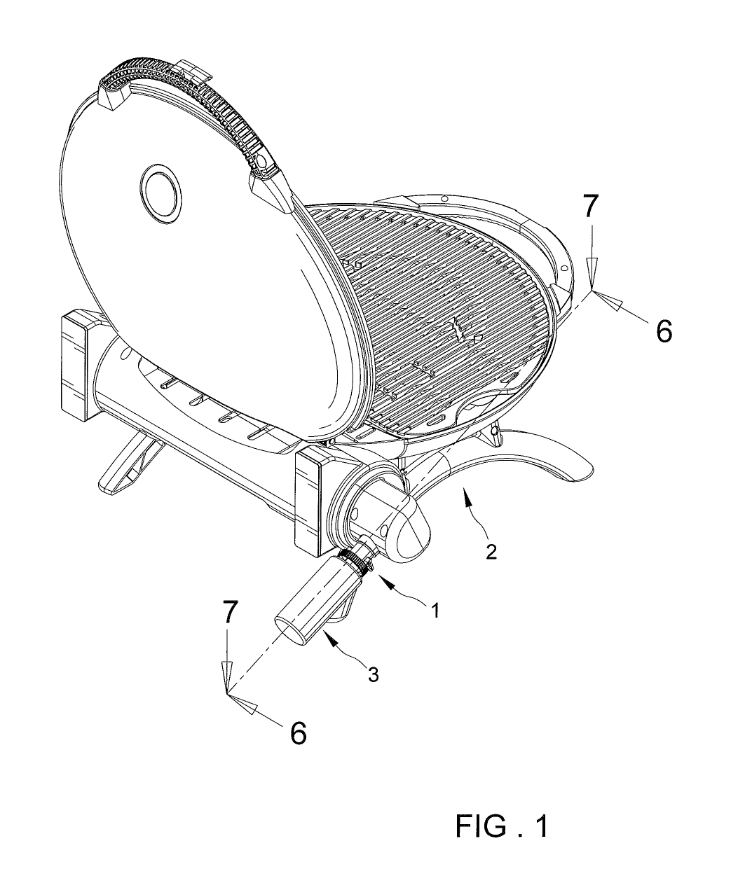

FIG. 2 is an illustrative view showing installation of the fuel can, fuel can adapter, and fuel device therebetween.

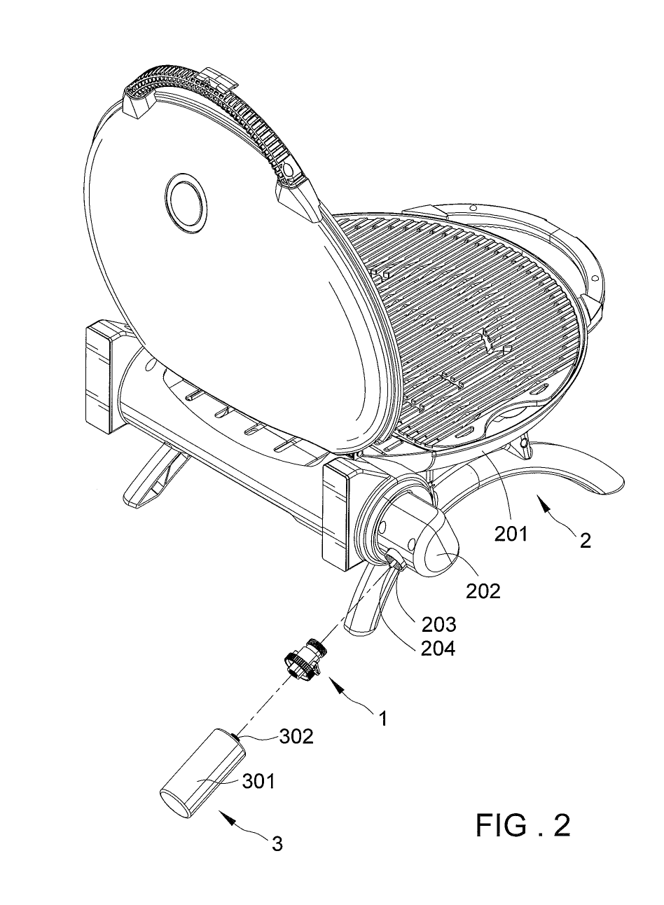

FIG. 3 is a perspective view of the fuel can adapter shown in FIG. 1.

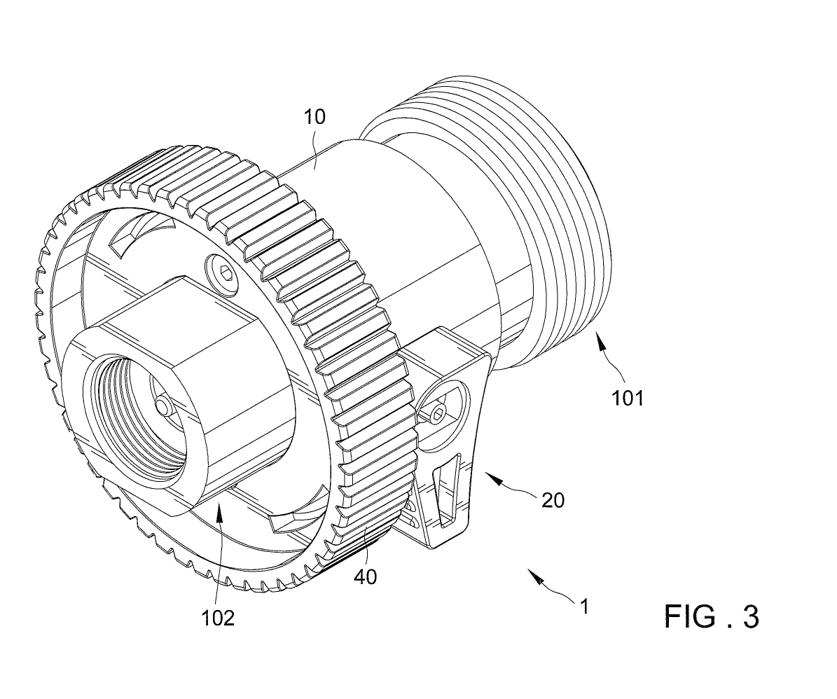

FIG. 4 is an exploded perspective view of the fuel can adapter shown in FIG. 3.

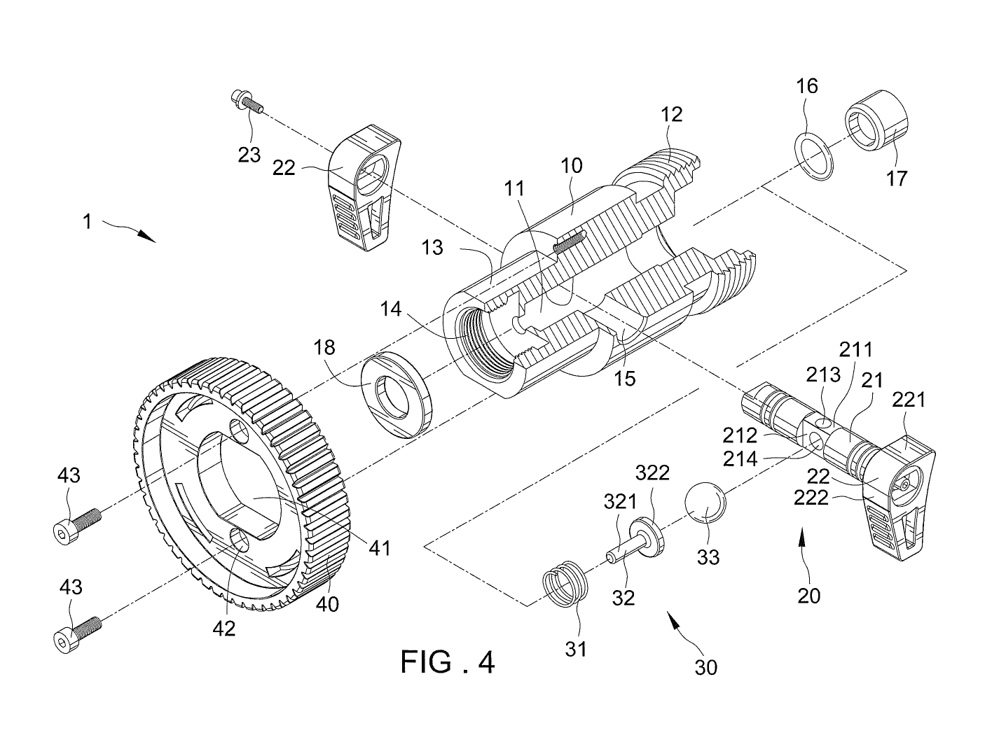

FIG. 5 is another exploded perspective view of the fuel can adapter taken from a different view than that of FIG. 4.

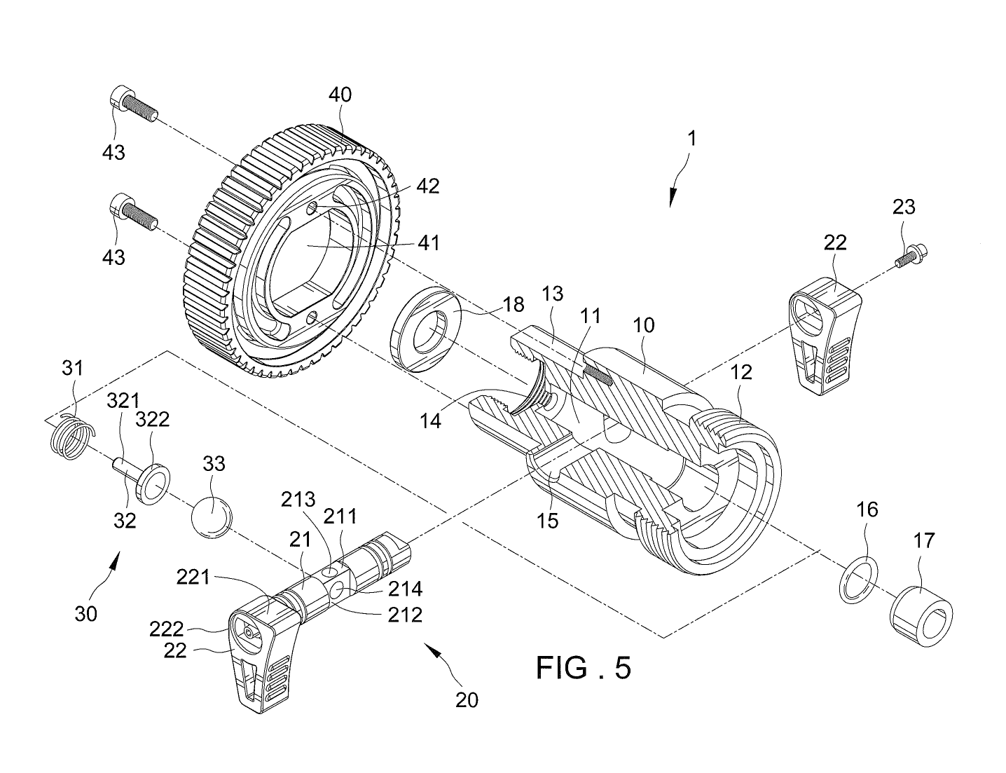

FIG. 6 is a partial, cross-sectional view taken along line 6-6 of FIG. 1.

FIG. 7 is a partial, cross-sectional view taken along line 7-7 of FIG. 1.

FIG. 8 is a cross-sectional view similar to FIG. 6, but shows the fuel can adapter in another operation position.

FIG. 9 is a cross-sectional view similar to FIG. 7, but shows the fuel can adapter in another operation position

FIG. 10 is an illustrative view showing installation of a conventional fuel can on the fuel device shown in FIG. 1, and with the fuel can having a threaded head.

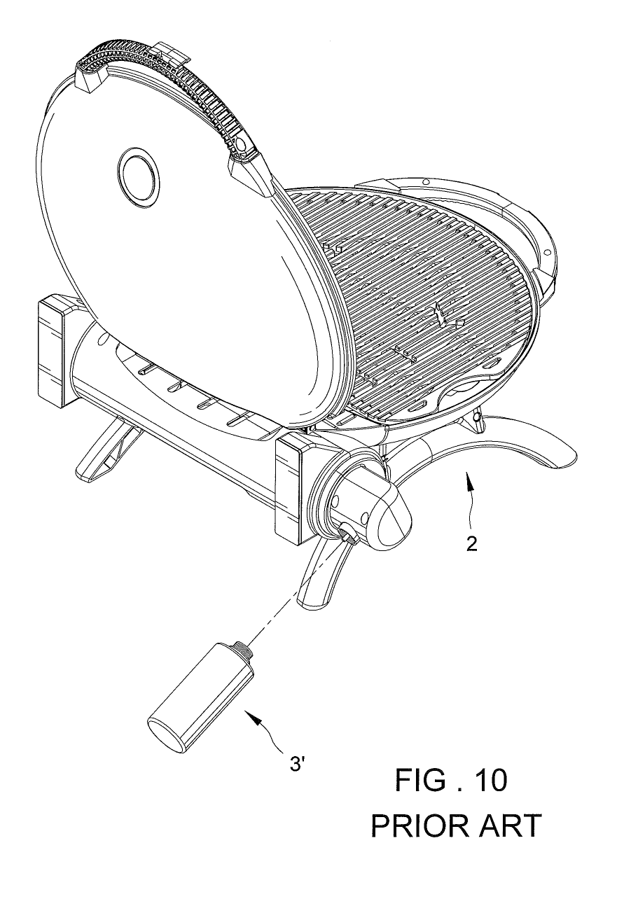

### DETAILED DESCRIPTION OF THE PREFERRED EMBODIMENT

Referring to the drawings, a fuel can adapter 1 in accordance with the present invention includes a first end 101 adapted to connect to a fuel device 2 such as a barbecue stove as illustrated and a second end 102 adapted to connect to a fuel can 3, respectively. Particularly, the fuel device 2 has a body 201 with a fuel can connecting section 202 which includes a cavity 203 which has an opening at an end thereof and which is open to outside, and a needle 204 which is disposed in the center of the cavity 203 and extends outwards of the opening. Additionally, the cavity 203 has a threaded wall formed on its peripheral wall. Particularly, the fuel can 3 includes a reservoir 301 with a head 302 which includes a threaded wall formed on its outer periphery, and a valve 303 which is disposed in the head 302 and is adapted to be urged to open to allow fuel flow out of the fuel can 3.

The fuel can adapter 1 includes a coupling member 10 including a threaded section 12 which is formed annularly on its outer peripheral wall. The threaded section 12 is to be engaged with the threaded wall of the cavity 203 when connecting the fuel can adapter 1 to the fuel device 2. Additionally, the coupling member 10 includes a gripping member 40, which is utilized to facilitate user threading the fuel can adapter 1, mounted on its outer peripheral wall. In addition, the gripping member 40 may be provided with a grid pattern, thereby preventing the user from slippage when threading the fuel can adapter 1. The gripping member 40 is prevented from relative rotation with respect to the coupling member 10 during the threading process of the coupling member 10 into the cavity 203. Preferably, the coupling member 10 includes a section of outer peripheral wall defined as a limiting section 13 for the gripping member 40. The limiting section 13 has a non-circular cross-sectional shape; and the gripping member 40 includes a through hole 41, which has a cross-sectional shape conforming to that of the limiting section 13, inserted by the limiting section 13 of the coupling member 10 for accomplishing the nonrotatably engagement therebetween. Preferably, the cross-sectional shapes of the limiting section 13 and the through hole 41 include two opposing flat edges and two opposing arcuate edges. In addition, the gripping member 40 may further include at least one aperture 42 extending therethrough for allowing a fastener 43 to be inserted, and the fastener 43 then engage with the coupling member 10 so as to fix the gripping member 40 on the coupling member 10. However, other means for fixing the coupling member 10 and the gripping member is within the scope of invention.

The coupling member 10 further includes a first channel 11 and a second channel 15 delimited by its inner peripheral wall. The first 11 and second 12 channels both extend through the coupling member 10 and each channel 11, 12 has two openings defined at two opposing ends thereof. Additionally, the first channel 11 extends in a first direction and the second channel 15 extends in a second direction which crosses the first direction. Preferably, the first channel 11 is connected to and is in communication with the second channel 15. Preferably, the first direction corresponds with the longitudinal direction that extends from the threaded section 12 to the limiting section 13 of the coupling member 10. Furthermore, the first channel 11 includes a threaded section 14 formed at the end opposite to the end at which the threaded section 12 is formed. The threaded section 14 is to be engaged with the threaded wall of the head 302 when connecting the fuel can adapter 1 to the fuel can 3.

The fuel can adapter 1 further includes a switch mechanism 20 engaged with the coupling member 10 and being operable in one position that a valve assembly 30 engaged therewith and disposed in the first channel 11 would urge the valve 303 of the connected fuel can 3 to open such that fuel in the fuel can 3 can flow thereout and through the first channel 11 to the fuel device 2, and another position that the valve assembly 3 would disengage with the valve 303 and in this connection fuel in the fuel can 3 would not flow thereout. The switch mechanism 20 includes a shank 21 which is inserted in the second channel 15 and is rotatable therein in response to shifting of the switch mechanism 20 from one operation position to another. Preferably, the shank 21 and the second channel 15 have substantially circular cross sections. Further, at least one operation handle 22, which is used as a user-input for rotating the shank 21, is fixed to an end of the shank 21 and is disposed outside the second channel 15. Preferably, the shank 21 includes two opposing ends and two operation handles 22 fixed to the two ends, respectively. Further, a fastener 23 is utilized to fix the operation handle 22 to the shank 21, but other means is within the scope of the invention. Additionally, in order to facilitate selection of operation positions of the switch mechanism 20, the operation handle 22 is provided with an indication, which could be an on/off sign.

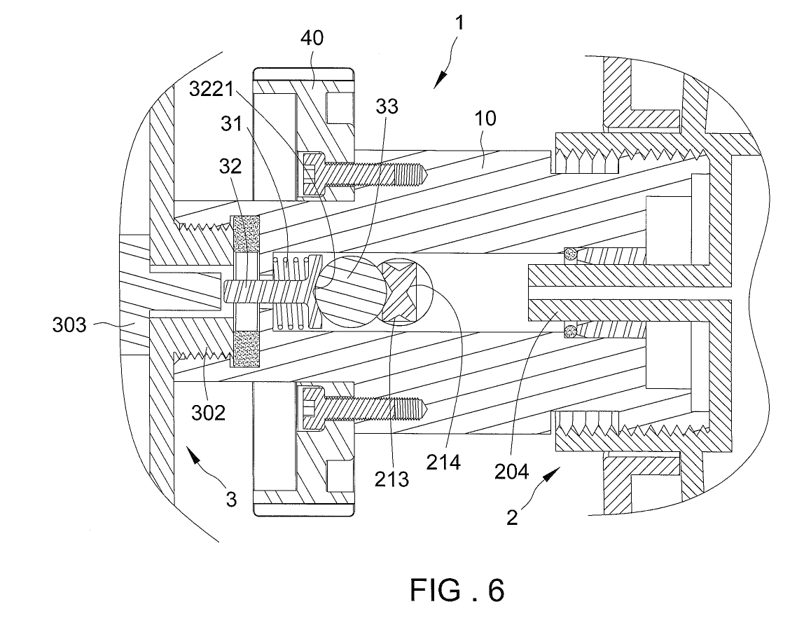

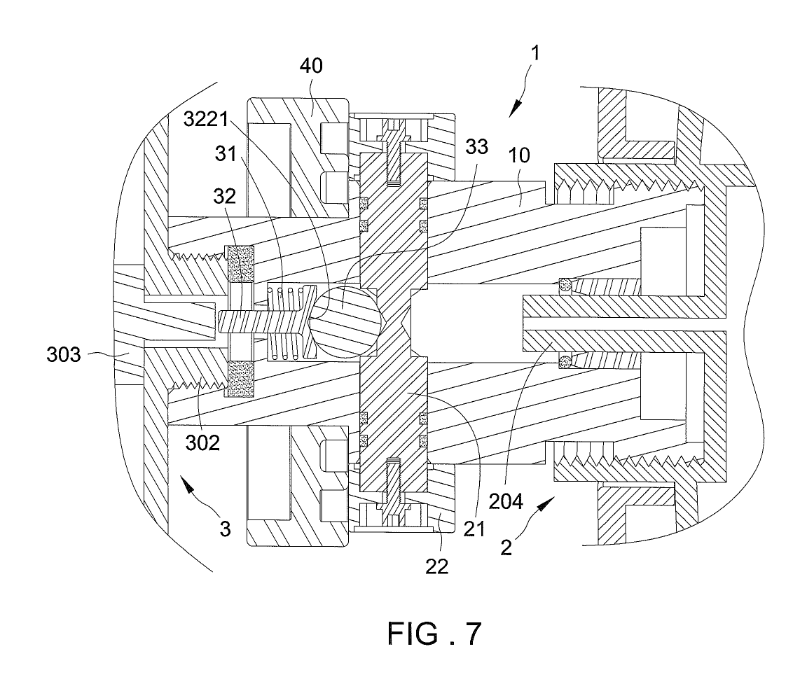

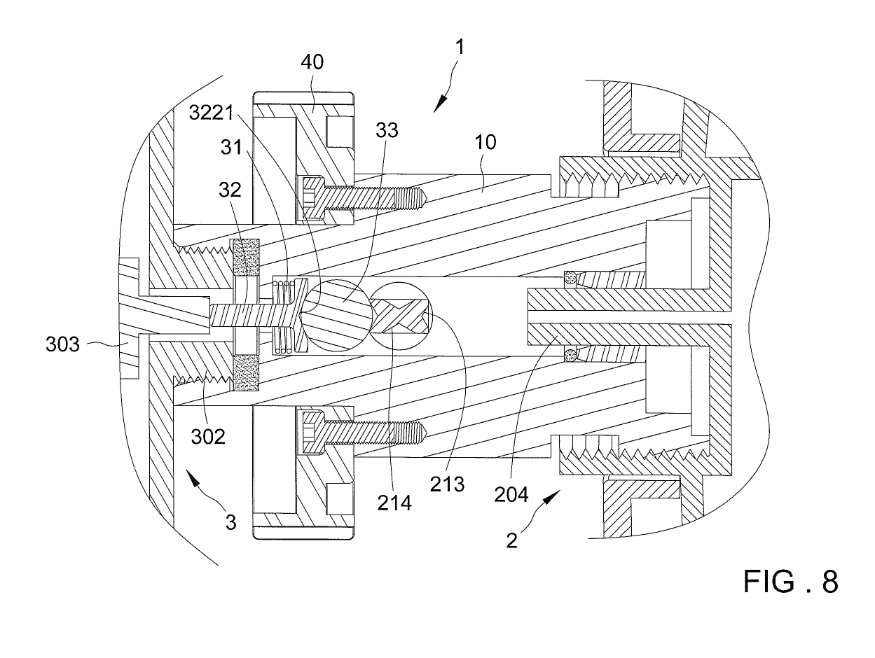

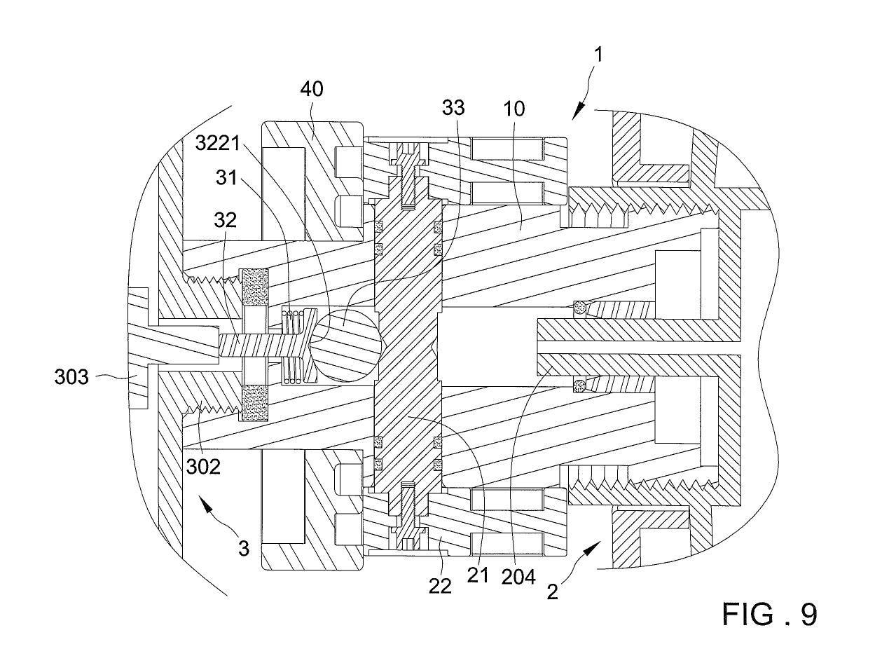

The valve assembly 30 is engaged with an engaging section which is defined in the shank 21 and is disposed in the first channel 11. Preferably, the engaging section is defined between the ends of the shank 21. Preferably, the engaging section has a quadrilateral cross section. Preferably, the engaging section is inset into the peripheral edge of the shank 21. The engaging section includes two opposing first engaging surfaces 211 and two opposing second engaging surfaces 212, and the two first engaging surfaces 211 are spaced from each other at a first distance while the two second engaging surfaces 212 are spaced from each other at a second distance which is shorter than the first distance. The valve assembly 30 includes an elastic element 31, a tappet 32 including a first body section 321 and a second body section 322 which is formed on an end of the first body section 321 and has a cross sectional area larger than that of the first body section 321. The first body section 321 of the tappet 32 inserts through the elastic element 31, and the elastic element 31 has one end retained by peripheral wall of the first channel 11 and another end retained by one side of the second body section 322. In this connection, the tappet 32 is adapted to be biased by the elastic element 31. The valve assembly 30 further includes a pushing member 33 engaged with the second body section 322 of the tappet 32 and the engaging section of the shank 21. Preferably, the pushing member 33 is a spherical ball. Preferably, the pushing member 33 is made of metal. Consequently, the pushing member 33 is engaged with one of the second engaging surfaces 212 and the tappet 32 is disengaged from the valve 303 when the switch mechanism 20 is in the position that fuel in the fuel can 3 would not flow thereout (as shown in FIGS. 6 and 7); and the pushing member 33 is engaged with one of the first engaging surfaces 211 and the tappet 32 is urged to push the valve 303 to open when the switch mechanism 20 is in the position that fuel in the fuel can can flow thereout (as shown in FIGS. 8 and 9).

Although the switch mechanism 20 can selectively utilize the two first 211 and two second 212 engaging surfaces to coact with the valve assembly 30, the switch mechanism 20 may only utilize one first 211 and one second 212 engaging surfaces to coact with the valve assembly 30. In this regard, the gripping member 40 is utilized to restrain rotation of the operation handle 22 in order to accomplish the result. Specifically, the operation handle 22 includes its peripheral edge defining a first abutting surface 221 and a second abutting surface 222 which are interchangeably utilized for abutting a side of the gripping member 40, and the first abutting surface 221 extends in one direction whereas the second abutting surface 222 extends in another direction substantially transverse to that of the first abutting surface 211.

In addition, the fuel can adapter 1 includes a seal 16 for preventing fuel leak between the first channel 11 and the needle 204, and a clip ring 17 for allowing the needle 204 to be securely engaged in the first channel 11. The fuel can adapter 1 also include a seal 18 for preventing fuel leak between the head 302 of the fuel can 3 and the first channel 11.

Further, each of the first engaging surfaces 211 includes a recess 213 inset thereinto and each of the second engaging surfaces 212 include a recess 214 inset thereinto, respectively. Likewise, the second body section 322 of the tappet 32 includes a recess 3221 inset thereinto. These recesses 213, 214, 3221 are provided for facilitating engagement of the pushing member 33 with the selected first 211 or second 212 engaging surface and the tappet 32.

While the specific embodiments have been illustrated and described, numerous modifications come to mind without significantly departing from the spirit of invention and the scope of invention is only limited by the scope of accompanying claims.

What is claimed is:

1. A fuel can adapter adapted to connect a fuel can to a fuel device, comprising:
a coupling member including a first channel which is adapted to allow fuel in the fuel can to flow therethrough to the fuel device and a second channel;
a switch mechanism disposed in the second channel which is in communication with the first channel;
a valve assembly disposed in the first channel and engaged with the switch mechanism, and
wherein the switch mechanism is operable in one position that the valve assembly engaged therewith would cause fuel in the fuel can to be discharged and flow through the first channel to the fuel device, and another operation position that fuel in the fuel can would not flow thereout.

2. The fuel can adapter as claimed in claim 1 wherein the switch mechanism includes a shank which is inserted in the second channel and is rotatable therein in response to shifting of the switch mechanism from one operation position to another.

3. The fuel can adapter as claimed in claim 2 wherein the switch mechanism includes at least one operation handle, which is used as a user-input for rotating the shank, fixed to an end of the shank and is disposed outside the second channel.

4. The fuel can adapter as claimed in claim 2 wherein the shank defines an engaging section to engage with the valve assembly, and wherein the engaging section includes two opposing first engaging surfaces and two opposing second engaging surfaces, and with the two first engaging surfaces spaced from each other at a first distance while the two second engaging surfaces spaced from each other at a second distance which is shorter than the first distance.

5. The fuel can adapter as claimed in claim 3 wherein the shank defines an engaging section to engage with the valve assembly, and wherein the engaging section includes two opposing first engaging surfaces and two opposing second engaging surfaces, and with the two first engaging surfaces spaced from each other at a first distance while the two second engaging surfaces spaced from each other at a second distance which is shorter than the first distance.

6. The fuel can adapter as claimed in claim 4 wherein the valve assembly includes an elastic element, a tappet adapted to be biased by the elastic element.

7. The fuel can adapter as claimed in claim 5 wherein the valve assembly includes an elastic element, a tappet adapted to be biased by the elastic element.

8. The fuel can adapter as claimed in claim 6 wherein the valve assembly includes a pushing member engaged with the tappet and the shank.

9. The fuel can adapter as claimed in claim 7 wherein the valve assembly includes a pushing member engaged with the tappet and the shank.

10. The fuel can adapter as claimed in claim 8 wherein the pushing member is engaged with one of the second engaging surfaces and the tappet is located in a first position when the switch mechanism is in the position that fuel in the fuel can would not flow thereout, and wherein the pushing member is engaged with one of the first engaging surfaces and the tappet is located in a second position when the switch mechanism is in the position that fuel in the fuel can can flow thereout.

11. The fuel can adapter as claimed in claim 9 wherein the pushing member is engaged with one of the second engaging surfaces and the tappet is located in a first position when the switch mechanism is in the position that fuel in the fuel can would not flow thereout, and wherein the pushing member is engaged with one of the first engaging surfaces and the tappet is located in a second position when the switch mechanism is in the position that fuel in the fuel can can flow thereout.

12. The fuel can adapter as claimed in claim 3 wherein the coupling member includes a gripping member mounted thereon for facilitating engagement with the fuel device, and wherein the gripping member is utilized to restrain rotation of the operation handle, with the operation handle including a peripheral edge defining a first abutting surface and a second abutting surface which are interchangeably utilized for abutting a side of the gripping member, and with the first abutting surface extending in one direction whereas the second abutting surface extends in another direction substantially transverse to that of the first abutting surface.

13. The fuel can adapter as claimed in claim 10 wherein the coupling member includes a gripping member mounted thereon for facilitating engagement with the fuel device, and wherein the gripping member is utilized to restrain rotation of the operation handle, with the operation handle including a peripheral edge defining a first abutting surface and a second abutting surface which are interchangeably utilized for abutting a side of the gripping member, and with the first abutting surface extending in one direction whereas the second abutting surface extends in another direction substantially transverse to that of the first abutting surface.

14. The fuel can adapter as claimed in claim 11 wherein the coupling member includes a gripping member mounted thereon for facilitating engagement with the fuel device, and wherein the gripping member is utilized to restrain rotation of the operation handle, with the operation handle including a peripheral edge defining a first abutting surface and a second abutting surface which are interchangeably utilized for abutting a side of the gripping member, and with the first abutting surface extending in one direction whereas the second abutting surface extends in another direction substantially transverse to that of the first abutting surface.

15. The fuel can adapter as claimed in claim 4 wherein each of the first engaging surfaces includes a recess inset thereinto and each of the second engaging surfaces include a recess inset thereinto, respectively.

16. The fuel can adapter as claimed in claim 5 wherein each of the first engaging surfaces includes a recess inset thereinto and each of the second engaging surfaces include a recess inset thereinto, respectively.

17. The fuel can adapter as claimed in claim 8 wherein each of the first engaging surfaces includes a recess inset thereinto and each of the second engaging surfaces include a recess inset thereinto, respectively.

18. The fuel can adapter as claimed in claim 9 wherein each of the first engaging surfaces includes a recess inset thereinto and each of the second engaging surfaces include a recess inset thereinto, respectively.

19. The fuel can adapter as claimed in claim 17 wherein the pushing member is a spherical ball.

20. The fuel can adapter as claimed in claim 18 wherein the pushing member is a spherical ball.
